(19) United States
(12) Patent Application Publication
(10) Pub. No.: US 2004/0048617 A1
(43) Pub. Date: Mar. 11, 2004

(54) Method and system for treatment of call attempts in a next generation network

(76) Inventors: Glen MacArthur, Washington, NJ (US); Tanya Hurley, Hillsborough, NJ (US); Santanu Sarkar, Piscataway, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 10/235,364

(22) Filed: Sep. 5, 2002

(51) Int. Cl. H04Q 7/20

(52) U.S. Cl. 455/445

(57) ABSTRACT

In a next generation network service manager or call agent softswitch, a call processor controls the processing of ineffective call attempts by using a plurality of predefined call treatment groups that specify a plurality of actions to be taken for specific call attempts. A call attempt may result in the playing of a tone or announcement, the routing of the call to an operator or other service or the playing of a tone and collection of digits from the call originator. Treatment groups may also contain secondary classmark distinctions that enable the playing of different tones, announcements or other treatment actions depending on the identity of the call originator. The duration of the tone or announcements can also be controlled using duration fields. The tone or announcement may be played by an announcement server or more effectively at a hub (“line”) gateway nearest the edge device from which the call originates thereby saving network resources.

### FIELD OF THE INVENTION

This invention is related to a method and system for processing calls in a next generation telecommunications network. More specifically, the method and system provides an improved way to primarily handle ineffective call attempts in a software-centric switch, or softswitch, in a next generation network thereby enabling flexible call processing of all call attempt dispositions.

### BACKGROUND

In the existing circuit switched “legacy” network, call processing of ineffective call attempts has been rather limited. Because the public switched telephone network (PSTN) contains both the signaling (control) and the transport (bearer path) planes, call processing treatments were inherently centralized. For example, all busy signals (slow or fast) or other call processing treatments, such as recorded announcements, had to originate at the centralized switches usually located at the telephone company central office. Thus, in order to provide a busy signal to a customer whose call could not be processed because the telephone at the called number was in use, the central office had to keep the originating phone in connected loop or circuit. This resulted in the use of a circuit until the originating phone user decided to terminate the busy signal or central office attempts to get the originating user to hang-up using a different tone or recording. Additionally, once a tone or announcement was provided to an originating caller of a failed call attempt there was no further processing possible.

In the last few years, software-centric switches sometimes known as call agents or softswitches were developed. These software-implemented switches enabled more and flexible call treatments, including announcements, to be generated by a device anywhere in the network. Basictones, such as “line busy” conditions, could be provided by the network ingress and egress devices (i.e. “gateways”). Such improvements were implemented in the original version of the Telcordia™ Call Agent Softswitch for Next Generation Networks. This implementation, however, did not provide for the possibility of external handling, announcement duration control or use of next generation gateway devices to provide all types of call treatments.

It would be desirable to have a system and method that could implement additional call treatments at different points in the network using a software-centric softswitch. It would be useful to supply not only tones but also announcements to the originating caller at more efficient and economic points in the network.

Further it would be desirable to have a system and method to implement a call treatment process in which the call can progress through one realm of the treatment logic to another. For example, an announcement followed by a live operator.

Additionally, it would be desirable to have a system and method that implements flexible duration controls that permit the user of a system to control the duration of the tone or announcement prior to additional processing.

It is desirable to have a system and method that enables the use of next generation gateway devices to provide many types of call treatments moving the providing of treatments closer to the edge of the network rather than centralizing such processing.

### SUMMARY

In accordance with the present invention a method and system for processing calls and applying call treatments to ineffective and other call attempts provides call processing software and an associated database of tables. The treatment group table specifies a sequence of one to three action identifiers. Each action Identifier field can be populated with a sequence of one or more actions, including, tone, announcement, route list, play tone and collect digits.

In the system and method of the present invention the treatment of a call attempt results in the direction of the service logic to a treatment group selected from the table of treatment groups. At that point, there is the ability to select one of N treatment group tuples. Once a treatment group tuple has been selected, the present invention allows for a plurality of action_types to be specified. The action_types are processed in order. For example, the first action_type might result in an announcement being generated for a specified duration. A second action_type could define a tone to be generated for an infinite time period. Another action_type could generate an announcement that states that the call originator will be forwarded to a live operator if the caller remains on the line (i.e., off-hook). The latter action_type would be specified as a route list.

Additionally, the action_types in a treatment group table tuple can also yield additional data item values. Action types such as “answer_supervision”, “cause_code”, “sip_status_code”, “sip reason_phrase” and “release_with_cause” provide additional functionality. For example, “release_with_cause” is a boolean flag to indicate to the call processing software whether or not treatment should be applied in this “switching machine” or whether an SS7 “REL” ISUP message should be sent immediately containing the cause code datafilled in the data item. Some of the “SIP” interaction with call attempt treatment processing can be implemented in additional tables. It is presented in this manner for clarity.

Furthermore, the method and system of the present invention also takes advantage of the network element location paradigm in the next generation softswitch. Voice over packet (VoP) networks move the transport plane away from the call processing control mechanism. The transport ingress and egress points (typically known as gateways) can be located anywhere. These gateways are able to provide some call treatments. The call processing software can determine whether the edge device (such as the gateway) can provide the treatment action or whether the traditional method of providing the treatment action with common devices is necessary. Executing the call treatment at the edge device results in significant savings to the overall network because only the edge device need remain in communication with the originating caller to provide many of the call treatments and the remaining network connection (i.e. bandwidth) to the edge device can be used to connect other calls.

Additionally, the use of treatment action sequencing and associated table control in the treatment system can result in being able to offer services typically requiring additional call processing software development.

Finally, use of the route list enables a call attempt to be routed to additional call processing such as connection to a live operator or other call processing device.

### BRIEF DESCRIPTION OF THE DRAWINGS

FIG. 1 depicts the architecture of a next generation network implementation of the present invention;

FIG. 2 depicts the call processing treatment flow for hardcoded point;

FIG. 3 depicts the call processing treatment flow for “tuple not found” treatments;

FIG. 4 depicts the call processing treatment flow for datafilled treatments;

FIG. 5 depicts the call processing treatment flow for cause code treatments, and;

FIG. 6 depicts the flow related to processing an announcement through an announcement server.

### DETAILED DESCRIPTION

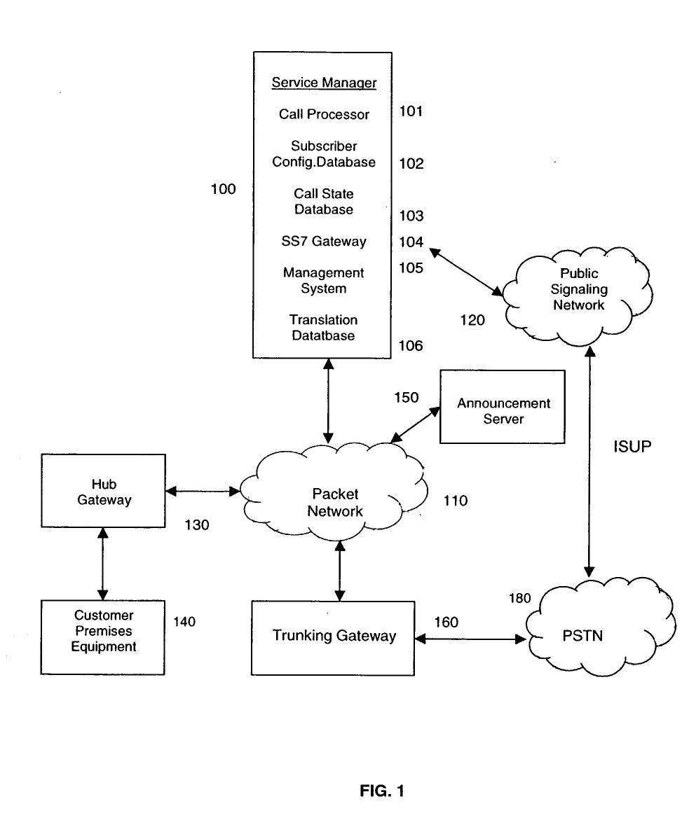

FIG. 1 depicts the architecture of a next generation network implementation of the present invention. In such an implementation, a call agent (softswitch), the Telcordia™ Service Manager (SM) 100 is a computer capable of executing a number of software modules and providing certain database functions. A Service Manager 100 will typically include a call processor 101, a subscriber configuration database 102, a call state database 103, a Signaling System 7 (SS7) gateway 104 and a management system 105. The call processor 101 within the Service Manager 100 establishes, manages and terminate service by exchanging signaling messages with hub gateways and trunking gateways, stores call-related records and accounting data and routes calls to and from the Public Switched Telephone Network (PSTN) 180. Within the Service Manager 100 the subscriber configuration database 102 stores all subscriber data and the translation database 106 stores network configuration and call processing data, both share the data with the call processor to establish calls. The call state database 103 is a real-time subsystem that maintains a record of each call processed by the Service Manager 100 and stores subscriber feature information and network configuration data used during call processing to enable faster access and efficient routing. The SS7 gateway 104 serves as the interface between the Service Manager and the SS7 public signaling network 120 enabling completion of calls on the PSTN 180. The management system 105 serves as a graphical user or machine interface for system management provisioning and maintenance and provides users of the Service Manager 100 with the interface to the call treatment tables described below.

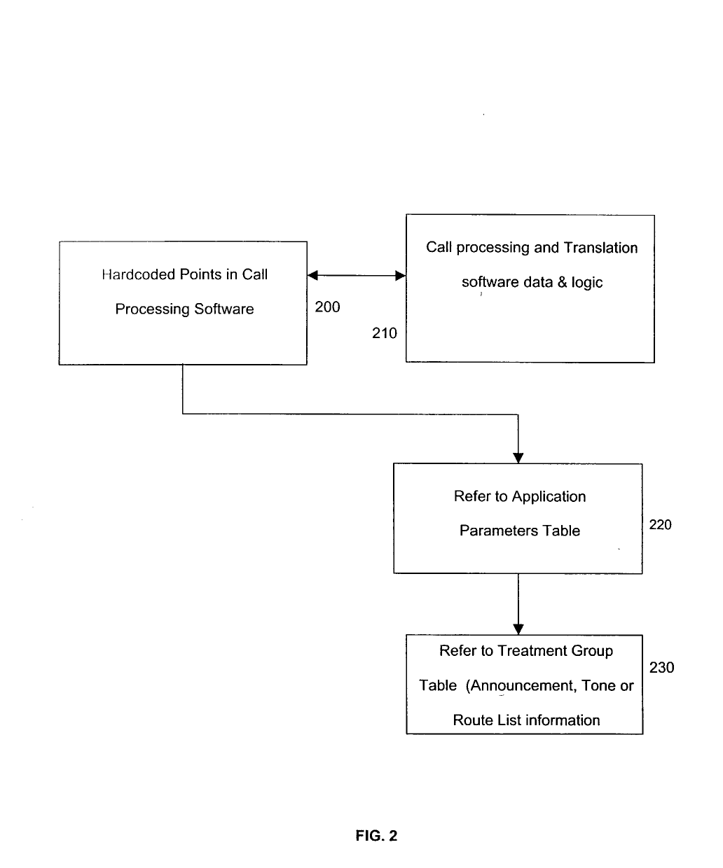

The call processor in the Service Manager (SM) 100 can encounter a need to “treat” a call attempt originating in the PSTN 180 or from customer premises equipment 140 connected to the packet network 110 through a “trunk” access or “line” gateway 130 in many different manners and at many different points. Throuhout this specification, the name “hub” refers to those gateways that are typically configured to serve “line” type endpoints. As depicted in FIG. 2 there can be hardcoded points in the call processing software 200 that direct the flow to an Application Parameter Table 220, which can be datafilled with the value of a treatment in the Treatment Group Table 230. These hardcoded points in call processing software 200 reference Application Parameter Table 220 data provided by call processing and translation data and software logic 210. Furthermore and using an example, certain feature processing hardcoded “points” in the call processing software have corresponding rows in the Application Parameters table can yield ANY treatment group name defined in the Treatment Group Table. Examples of feature releated application parameters are: “SCR_REJECTION_TREATMENT”, “SCA_REJECTION_TREATMENT”, “DENIED_ORIG_TREATMENT_ROUTE”, and “DENIED_TERM_TREAT_ROUTE.”

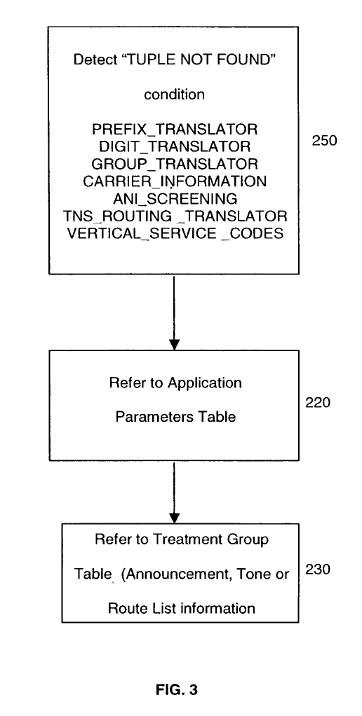

In accordance with the call processing flow depicted in FIG. 3, call processing may detect what is known as a “tuple not found” condition 250. This will result if the during call processing there is an inability to select a row from one of the following tables: PREFIX_TRANSLATOR, DIGIT_TRANSLATOR, GROUP_TRANSLATOR, CARRIER_INFORMATION, ANI_SCREENING, TNS_ROUTING_TRANSLATOR, and VERTICAL_SERVICE_CODES. Each of-the seven tables has a corresponding row in the APPLICATION_PARAMETERS table which can yield ANY treatment group name defined in the Treatment Group Tables. These are the seven translations tables that have a default “tuple (row) not found” treatments defined in the Applications Parameters table 220. Digit strings index each of the tables, with the exception of the Group Translator. Rather than force the data fill of all possible combinations, only those that are valid or “translatable” need to be populated. If a tuple (row) cannot be located by the call processing translations software, the call attempt will be routed to a treatment as determined by the Treatment Group Table 230.

An example of the treatment for PREFIX TRANSLATOR would be a misdial announcement because a failure to locate a tuple in this table is typically a result of dialing incorrectly. Such an announcement might be “We'sorry, your call cannot be completed as dialed, please hang-up and try again.”

An example of the treatment for DIGIT TRANSLATOR would typically be a vacant code announcement such as “We'sorry, the number you have dialed is not assigned, please check your number and try again.” Because “codes” (NPA's, NXX's, country codes) are datafilled in this table, a failure to locate a tuple in this table typically results when a code that is dialed is not assigned.

An example of the treatment for GROUP TRANSLATOR would typically be a network failure announcement such as “Due to a temporary failure, we cannot complete you call, pleas try again later.” The inability to select a tuple in this table is a result of a service provider data fill error since each index is a pointer from the DIGIT TRANSLATOR table datafill.

An example of a treatment for VERTICAL SERVICE CODE would typically be a servce not available announcement such as “The feature code you have dialed is not available or not valid.” Failure to locate a tuple in this table is due to the VSC dialed not being valid or not yet implemented in Service Manager software or not being offered by the service provider.

An example of a treatment for CARRIER INFORMATION would typically be a carrier access code invalid announcement such as “The carrier access code you have dialed is not valid, please check your carrier access code and try again. Failure to locate a tuple in this table is a result of the Interchange Carrier carrier Access Code (IC CAC) not being valid or not a dialable CAC from the VdoP domain it is being translated in.

An example of a treatment for ANI SCREENING would typically be a temporary failure announcement such as “We're sorry, you call did not go through. Please try your call again later.” The same treatment announcement is typical for a failure to locate a tuple in the TNS Routing Translator table.

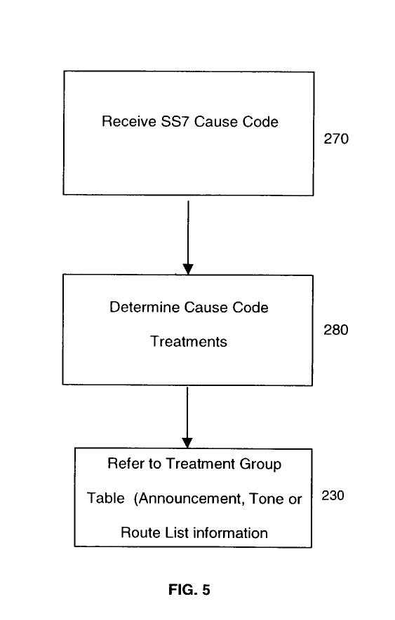

As depicted in the call processing flow diagram of FIG. 5, SM call processing will need to treat a call attempt if an SS7 cause code is received 270 requiring the Service Manager machine to provide the treatment. The call processing software will obtain the Treatment Group Name from the Cause Code Treatments table 280. Cause codes are used to define a call anomaly or condition that is transmitted in a release with cause message or for which a Treatment Group is needed. The Cause Code Treatment table maps each Cause Code to a Treatment Group at 280. The Treatment Group Table data also has cause codes. If a cause code is received from the ISUP SS7 network, the Cause Code Treatment table is accessed to get the Treatment Group to which the call is routed 230. In the Treatment Group table, the cause code is the cause code to send to the ISUP SS7 network with a release message when there is a need to tear down the call on the PSTN side. Any Treatment Group Name in the Cause Code Treatment table must first be defined in the Treatment Group Table. The aforementioned conditions refer to call attempts being received from the PSTN and call attempts being sent to the PSTN. That is, the cause code in the Cause Code Treatment table contains data for cause codes received from the PSTN. Cause codes in the Treatment Group table are cause codes sent to the PSTN.

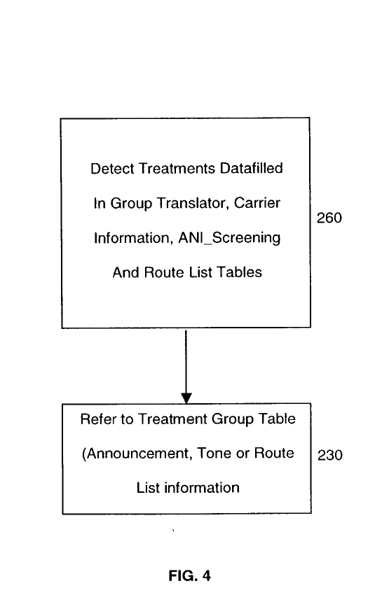

As depicted in the flow call processing flow diagram of FIG. 4, call processing may also need to “treat” a call attempt at datafillable points in the translations tables where the datafill points permit a Treatment Group Name to be specified 260. These points are in the following tables: Group Translator, Route List, Carrier Information and ANI_Screening. Treatments can also be defined in any defined application parameter that has a treatment group name as the argument (value). These can point to any Treatment Group name defined in the Treatment Group Table 230.

The Treatment Group Table lists all treatments. There needs to be a set of fixed unalterable “standard” treatments. The list of fixed Treatment Group Names is set forth in Table 1. Custom Treatment Groups may be defined by the user of the Service Manager 100 through the management system 105.

TABLE 1

| | |
|---|---|
| ACCOUNT_CODE_PROMPT | IPINCOMP_TRMT |
| ACT_DACT_ | LINE_BUSY |
| CONFIRMATION | |
| ADDRESS_INCOMPLETE | LNP_PROBLEM |
| ALL_TRUNKS_BUSY | MISDIALING_CAUSE_10 |
| ATMINCOMP_TRMT | MISDIALING_CAUSE_N8_N9 |
| BLV_PERMANENT_SIGNAL | NO_ROUTES_TO_IXC |
| CAC_NOT_DIALED | NO_USER_RESPONDING |
| CAC_NOT_REQUIRED | NUMBER_CHANGED |
| CAC_NOT_VALID | OUT_OF_BAND |
| CAC_OMITTED | OUTGOING_CALL_RESTRICTION |
| CALL_PARK_PARKED | PERM_SIGNAL |
| CALL_REJECTED | RETURN_CALL ANONYMOUS |
| CONGESTION_BUSY | RETURN_CALL_DENIED |
| COT_FAILED | SELECTIVE_CALL_REJECTION |
| COT_SUCCEEDED | SERVICE_NOT_AVAILABLE |
| DESTINATION_OUT | TEMPORARY_FAILURE |
| _OF_ORDER | |
| DNSTATE_TROUBLE | TNS_INVALID |
| EQUIPMENT_CONGESTION | TNS_UNEXPECTED |
| FEATURE_CONFIRMATION | TOLL_RESTRICTION |
| HOLD_RELEASED | VACANT_CODE |
| INCORRECT_DIGITS_ | VACANT_NUMBER |
| FROM_ICINC | |
| INVALID_AUTHORIZA- | |
| TION_CODE | |

Treatments are call processing routing destinations to which calls (or conditions) are directed that are not typically considered “normal” termination or connections. Treatments are the call processing translation results for abnormal, erroneous or congestion conditions encountered when processing a call or network agent event. Treatments allow the service provider the flexibility to route or terminate to various tones, announcement, lists of routes or combinations of these. Each treatment can be routed to a tone for a specified or infinite interval, an announcement for x number of cycles, a routing list index or a tone that prompts the caller to enter more digits.

An announcement is a message that can be played at any Announcement Server 150 configured for a given Service Manager (SM) 100. Announcements are treated as end-points in VoP connection and control level signaling protocols. Each announcement name is configured as an end-point in the Announcement Server 150. The SM 100 recognizes the endpoint by its announcement name and the domain name of the Announcement Server 150. Each announcement should have a unique announcement name. In the current embodiment of the invention the name may be up to 32 characters. The name should imply the message in the announcement. For example an announcement having the name “ALL_TRUNKS_BUSY_ANNC” could be used to name the announcement containing the message “All circuits are busy now, try your call again later.” The Announcement Names are the names of the endpoints in the Announcement Server 150 and are therefore specified by the vendor of the equipment. The recording of the announcement is part of the configuration of the Announcement Server hardware. No row may be deleted from the Announcement Table while it is still referenced elsewhere in the database such as references in the Hub Gateway Treatment Table or the Treatment Group Table.

The Hub Gateway Treatment Table stores portions of the signal text string that is sent to the hub gateway 130 that supports a particular tone or announcement. When the Action Type in a Treatment Group is a tone or announcement, the Action Identifier will have an Announcement Name. Even though a tone is going to be generated by the hub gateway 130, the supportive call processing logic has been designed to handle gateway devices that will be able to generate announcements as well as tones. Thus, the announcement_name data item is a variable in the software used to store tone and announcement names. This is also the reason that “tones” will be datafilled in the “ANNOUNCEMENTS” table. Call processing checks this table for an entry using the Hub Gateway Device Type and Announcement Name to see if the hub gateway 130 supports the tone or announcement. If any entry is found, call processing uses the Tone Event to identify the signal text string to be sent to the hub. If an entry is not found, a request to play the tone or announcement is sent to the Announcement Server. Hub Gateway Device Type uniquely identifies a specific Hub Gateway device type within the network.

Tone Event specifies the type of tone that is to be played by the device for the specified announcement. The Tone Event may be a default or may be specified from the defined set of tones: Busy Tone, Network Congestion Tone, Dial Tone, and Stutter Dial Tone.

Duration “d” specifies the number of milliseconds that the Service Manager (SM) will instruct the hub or gateway to play the tune. In the present embodiment the duration should be specified as an integer greater than zero.

A Treatment Group specifies a sequence of one or more Action Identifiers. Each Action Identifier can be datafilled from this enumerated list: tone, announcement, route list or play tone and collect digits. When a call is directed to a Treatment Group and there is a match on the treatment group name and a secondary class mark list, all actions specified are performed. If there is no match, the call is sent to a default fixed treatment group name—TEMPORARY_FAILURE. A Treatment Group is specified by a Treatment Group Name. This name is used to define a call processing treatment and is referenced during digit translation and other translation and call processing states of a call attempt. Some entries for a Treatment Group Name are pre-defined and made read only because they support internal call processing.

The design of the translation logic using the Treatment Group and associated tables is quite unique with respect to how call attempt treatments have been implemented in voice switching network elements. Typically, treating a call attempt meant directing it to an announcement or tone and cessation of call processing. In the Service Manager (SM) 100 treatment logic of the present invention, when call processing, through datafill or default action, is directed to a Treatment Group, there is the ability to select one of N treatment group tuples. N represents the number of Secondary Classmark List items defined for treatment group indexing plus 1 for the “wildcard”, (“@”) Secondary Classmark Value. In a practical sense, N would not normally be a large number. There are instances where one instance (i.e., tuple) of each treatment is sufficient. However, this functionality allows the selection of unique treatments based on the originator's Secondary Classmark List attributes. A practical example would be where two languages are commonplace. A Secondary Classmark List item could be defined for binding to originators where language A is preferred or needed. Another Secondary Classmark List item could be defined for language B and could be bound to originators using that language. The resultant datafill in each set of Treatment group Name tuples would point to announcements that were recorded in the language needed.

The Secondary Classmark List parameter is used for screening, charging and routing in the primary call processing translation tables. Valid values are listed in the Secondary Classmark Definition table. Default is “@” which is used as a wild card to mean “any” Secondary Classmark List. The Secondary Classmark List is used to select the group of up to three actions based on the Secondary Classmark List of the subscriber originating the call or the Trunk Group of the incoming call. The Secondary Classmark List is a key, but a wildcard may be used instead of a value to indicate that the Secondary Classmark List is not used in the selection criteria.

The Cause Code field is used to define a call anomaly SS7 release message cause code for which a Treatment Group was selected for call attempt disposal. A Cause Code may be an integer from zero through 999.

Answer Supervision is a parameter that specifies whether or not a treatment is to return “answer” supervision. If answer supervision applies to a treatment group, the treatment group is usually considered a billable call destination and is subject to charges to the originator. Thus, answer supervision is used to indicate if the call was answered and, therefore, should be billed under normal conditions.

Release with cause is a parameter that changes the processing of a call treatment. If Release with cause is specified in the Treatment Group that was indexed, then the call will not receive the treatment or treatments specified in the first or subsequent actions. Instead the datafilled cause code will be sent immediately with a release when there is a need to tear down the call on the ISUP, MSMP (Multiple Service Manager Protocol) or PRI (Primary Rate Interface) side.

In the preferred embodiment of the invention up to three treatments may be specified per Treatment Group. The three treatments are referred to as First Action, Second Action and Third Action respectively. For each action, a Type, a Name and Duration may be specified. The Type field may be specified as one of the desired actions from the following group: Tone, Announcement, Route List, and Play Tone and collect digits. This specifies the action that the call processing software will take upon encountering a treatment. Thus, if the action indicated Tone or Announcement, call processing will attempt to play the Announcement Name specified in the Action Name.

Once a Treatment Group has been selected the actions will be stepped-through in order. For example, a Treatment Group might first specify that an announcement be generated that states that if the call originator stays “on the line” (i.e., off-hook) he or she will be connected to a live representative of the service provider. The latter action is accomplished by specifying a route list as the Action Type. Since the route list can reference a Treatment Group and Treatment Group can reference a Route List there is a validation against the respective tables and the instances of the Route List and the Treatment Group need to be coordinated in order to remove the possibility of and endless loop. This means that loading of all the instances in a table at once is not possible.

The Treatment Group table has an alternate indexing mechanism. That is, an AIN trigger response may contain a “treatment” indexing (simple integer) value. In that case, the index is “looked-up” in the “Treatment_Group_Definition” table where a corresponding treatment_group_name would be obtained by the translation software.

The resultant datafill in a Treatment Group table tuple can also yield additional data items values such as “answer_supervision”, “cause_code”, “sip_status_code”, “sip_reason_phrase” and “release_with_cause.” The data item names listed above indicate the functionality each provides. For example “release_with_cause” is a Boolean flag used to indicate to the call processing software whether or not a treatment should be applied in this “switching machine” or an SS7 “REL” ISUP message sent immediately containing the cause code datafilled in this data item. The “sip_status_code” is similar to an SS7 cause code but is used in the Session Initiation Protocol (“SIP”). The “sip_reason_phrase” accompanies the status code in a SIP message to provide a definition of the exception or rejection to the “sip_status_code” in the tuple.

The action Name field entry will depend upon the action Type. If the action Type is Announcement, Tone or Play Tone and collect digits then a valid Announcement Name must be selected for entry in this field. If the action Type is Route List, then a valid Route List Name must be entered in the Route List Table.

The action Duration field is used for either Announcement or Tone action Types. In the preferred embodiment the field entry is an integer representing the number of times an announcement is cycled (i.e. played) having valid values between zero and six. This field is not used for action Types—Tone, Route List or Play Tone and Collect Digits.

An Announcement Server 150 is a device used for sending audio files or announcements to a remote end point under the direction of a service manager (SM). The end point can be either a Voice over Packet (VoP) gateway or a phone connected to a set-top box in a cable network or a personal computer (PC). Recorded announcements are defined by telephony service providers. They are played under specific conditions to a user of the telecommunications network. Announcements are stored locally on each Announcement Server 150. End-user customers typically hear these messages when a call cannot be processed. For example, if a customer is making a call to a number that is no longer in service, that customer would hear something similar to “I'm sorry, the number you have dialed is currently out of service. Please hang up and try your call again or call your operator for assistance.”

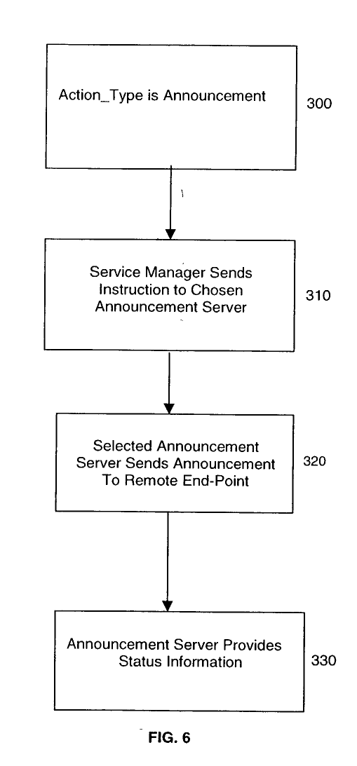

Communication flow in the Announcement Server 150 is depicted in FIG. 6. When a call is routed to a Treatment Group and the action type is an announcement 300, the Service Manager (SM) 100 chooses an Announcement Server 150 from the pool of Announcement Servers configured for the SM. In the first step 310 the Service Manager (SM) 100 sends an instruction to the Announcement Server 150 to create and delete connections as well as play announcements. Both the SM 100 and the Announcement Server 150 use a connection and control signaling protocol to communicate The SM formulates the endpoint name as follows. The local name is the announcement name. A backslash and the value of the Duration Filed in the Treatment Group Table are appended to the local name. Finally the domain name of the Announcement Server is used as the fully qualified domain name for the endpoint name. An endpoint name in this format is “VACANT_CODE/Loop=4@announment_server_{—}1 .SM02.telcordia.com.”

In the second step 320 the Announcement Server 150 sends the announcement file (in the form of packets representing audio) to the remote end point where the file is decoded—that is, “played” to the user. The Announcement Server 150 sends the file using the Real-time Transport Protocol (RTP). The end point identification consists of an IP address and an RTP port.

In the final step 330 within the Announcement Server, the Announcement Server 150 provides status information, such as the indication that an announcement was transmitted, through a Simple Network Management Protocol (SNMP) interface. An SNMP agent element residing on the Announcement Server element will communicate with an SNMP Manager residing on a customer's System Manager element.

An Announcement Server 150 provides call processing treatments that take the form of an announcement message. Attributes of an Announcement Server 150 are concerned with the physical and logical definitions of its existence in the network. Individual announcements are defined in the Announcement Table. Each Announcement Server 150 is assumed to support all the announcements in the Announcement Table.

Using the management system 105 of the Service Manager (SM) 100 an Announcement Server 150 is created by first specifying an Announcement Server name. Each Announcement Server 150 in the network needs to have a unique identifier. Additionally, the Announcement Server domain name should be specified. The fully qualified domain name (FQDN) for the Announcement Server is a logical alphanumeric address that can be translated into a physical IP address associated with a device connected to the VoP transport plane (e.g. IP backbone network).

The above description has been presented only to illustrate and describe the invention. It is not intended to be exhaustive or to limit the invention to any precise form disclosed. Many modifications and variations are possible in light of the above teaching. The applications described were chosen and described in order to best explain the principles of the invention and its practical application to enable others skilled in the art to best utilize the invention on various applications and with various modifications as are suited to the particular use contemplated.

We claim:

1. A method for processing ineffective call attempts in a telecommunication network having a software-implemented call agent containing a call processor comprising the steps of:
determining at the call processor that a call attempt requires treatment;
selecting the treatment from a set of treatment groups predefined in a treatment group table accessed by the call processor;
wherein each of said treatment groups comprises one or more action types selected from the group consisting of tone, announcement, route list, and play tone and collect digits.

2. The method of claim 1 further wherein the treatment group further comprises a secondary classmark enabling the action types of the treatments within a treatment group to differ based on a characteristic of the call attempt or call originator.

3. The method of claim 1 further wherein the treatment group contains information related to the duration that each tone orannouncement is to be played for a specific treatment.

4. The method of claim 1 further comprising the routing of the call to an address specified in the route list if the action type specified is route list.

5. The method of claim 3 further comprising the playing of a tone followed by the collection of digits input by the call originator on the customer premises equipment used by the call originator if the action type specified is play tone and collect digits.

6. The method of claim 1 wherein the call processor determines if the action type can be accomplished by a hub gateway.

7. The method of claim 6 wherein the hub gateway executes the treatment or treatments specified in the treatment table.

8. A system for processing ineffective call attempts in a next generation telecommunications network having a software-implemented call agent containing a call processor comprising:
a database of treatments defined by actions to be taken for specific call attempts wherein the actions are selected from the group consisting of tone, announcement, route list, and play tone and collect digits;
means for determining if a call attempt requires treatment;
means for selecting a treatment from the database of treatments;
means for effecting the selected call treatment or treatments.

9. The system of claim 8 wherein the database of treatments further comprises a secondary classmark indicator that enables the selection of treatments within a treatment group based on one or more characteristics of the call attempt or call originator.

10. The system of claim 9 wherein the database of treatments further comprises a duration field for specifying the duration of a tone or announcement.
